(19) United States
(12) Patent Application Publication
(10) Pub. No.: US 2015/0074301 A1
(43) Pub. Date: Mar. 12, 2015

(54) HOST BUS DRIVER VERIFYING APPARATUS, HOST BUS VERIFICATION SYSTEM, AND COMPUTER PRODUCT

(71) Applicant: FUJITSU LIMITED, Kawasaki-shi (JP)

(72) Inventor: Masato Kawamura, Machida (JP)

(73) Assignee: Fujitsu Limited, Kawasaki (JP)

(21) Appl. No.: 14/454,910

(22) Filed: Aug. 8, 2014

(30) Foreign Application Priority Data
Sep. 11, 2013 (JP) 2013-188863

(51) Int. Cl. G06F 13/38; G06F 13/10

(52) U.S. Cl. CPC G06F 13/387; G06F 13/102
USPC 710/104

(57) ABSTRACT

A host bus driver verifying apparatus is connected, through a host bus adapter, to a higher-order system and includes a storage device preliminarily storing correspondence relation information that correlates an operating system type operating in the higher-order system, a host bus adaptor type, and a driver type of the host bus adaptor; and a processor that obtains for the host bus adaptor, the driver type to be set in the higher-order system to which connection is made. The processor obtains the driver type based on the correspondence relation information, and connection information that includes information concerning the operating system type and the host adaptor type and that is received, via host bus adapter, from the higher-order system to which connection is made. The processor further verifies whether the obtained driver type matches a driver type set for a host bus adaptor in the higher-order system to which connection is made.

### CROSS REFERENCE TO RELATED APPLICATIONS

This application is based upon and claims the benefit of priority of the prior Japanese Patent Application No. 2013-188863, filed on Sep. 11, 2013, the entire contents of which are incorporated herein by reference.

### FIELD

The embodiments discussed herein are related to a host bus driver verifying apparatus, a host bus verification system, and a computer product.

### BACKGROUND

The driver of a host bus adaptor (HBA) of a server is set corresponding to the apparatus connected to the HBA. According to a related technique, for example, when a host is connected to a switch, a managing apparatus determines the reliability of the combination of attribute information concerning the HBA and attribute information concerning the switch. According to another technique, when a basic apparatus is replaced in a managed system, a management system controlling the basic apparatus identifies the basic apparatus related to the replaced basic apparatus and, thereafter, obtains the compatibility of the basic apparatus from compatibility information retained by the management system. According to another technique, a disk array apparatus acquires information from an HBA information management database (DB) that acquires connection information concerning the connection among a server apparatus, a fiber channel (FC) switching apparatus, and a storage apparatus, through an FC switching apparatus and that combines the connection information to manage the information (see, e.g., Japanese Laid-Open Patent Publication Nos. 2006-178720, 2000-353108, and 2005-322069).

However, according to the conventional techniques, it is difficult to verify a driver for the HBA for an apparatus connected to the HBA retained by a system. For example, the system has to store information concerning the proper driver for the HBA corresponding to the combinations of the version numbers of the operating system (OS) of the system, the type of HBA, the type of the apparatus connected thereto, and the version numbers of the firmware of the apparatus connected thereto. Therefore, the greater the number of combinations, the greater the amount of information is.

### SUMMARY

According to an aspect of an embodiment, a host bus driver verifying apparatus is configured to be connected, through a host bus adapter, to a higher-order system. The host bus driver verifying apparatus includes a storage device configured to preliminarily store correspondence relation information that correlates an operating system type operating in the higher-order system, a host bus adaptor type, and a driver type of the host bus adaptor; and a processor configured to obtain for the host bus adaptor, the driver type to be set in the higher-order system to which connection is made. The processor obtains the driver type based on the correspondence relation information stored in the storage device and connection information that includes information concerning the operating system type and the host adaptor type and that is received, via host bus adapter, from the higher-order system to which connection is made. The processor is further configured to verify whether the obtained driver type matches a driver type set for a host bus adaptor in the higher-order system to which connection is made.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of operation of a host bus verification system according to an embodiment;

FIG. 2 is an explanatory diagram of a first example of a storage system;

FIG. 3 is an explanatory diagram of a second example of the storage system;

FIG. 4 is an explanatory diagram of a third example of the storage system;

FIG. 5 is a block diagram of an example of a hardware configuration of a server;

FIG. 6 is a block diagram of an example of a hardware configuration of a storage apparatus;

FIG. 7 is a block diagram of an example of a functional configuration of the server;

FIG. 8 is a block diagram of an example of functional configuration of the storage apparatus;

FIG. 9 is an explanatory diagram of an example of the contents of an HBA DB;

FIG. 10 is an explanatory diagram (Part I) of an operation example of a verification process for an HBA driver;

FIG. 11 is an explanatory diagram (Part II) of the operation example of the verification process for the HBA driver;

FIG. 12 is a flowchart (Part I) of an example of a procedure for an HBA driver verification process executed by the server;

FIG. 13 is a flowchart (Part II) of the example of the procedure for the HBA driver verification process executed by the server;

FIG. 14 is a flowchart of an example of a procedure for an HBA inquiry command response process; and

FIG. 15 is a flowchart of an example of a procedure for an HBA driver verification process executed by the storage apparatus.

### DESCRIPTION OF EMBODIMENTS

Embodiments of a host bus driver verifying apparatus, a host bus verification system, and a computer product will be described in detail with reference to the accompanying drawings.

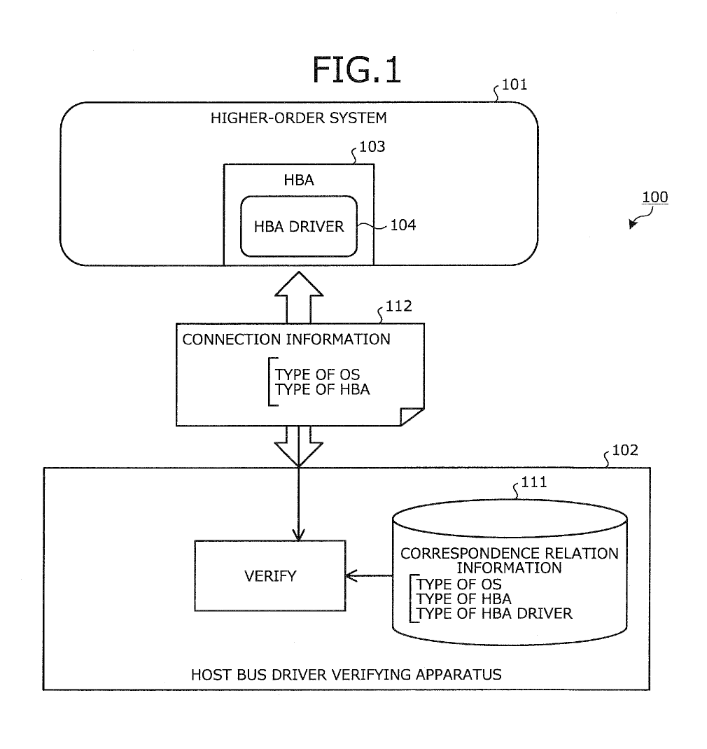

FIG. 1 is an explanatory diagram of an example of operation of a host bus verification system according to an embodiment. A host bus verifying apparatus 100 according to the embodiment includes a higher-order system 101 and a host bus driver verifying apparatus 102 in an order lower than that of the higher-order system 101. The host bus verifying system 100 is a system that verifies a driver of a host bus adaptor included in the higher-order system 101. Hereinafter, the host bus adaptor will be referred to as “HBA”. The driver for the HBA will be referred to as “HBA driver”.

The higher-order system 101 is a system that controls the overall host bus verification system 100; is, for example, a server providing users with services; and includes an HBA 103. The host bus driver verifying apparatus 102 is an apparatus that verifies the HBA driver operating in the higher-order system 101 for an apparatus connected to the host bus driver verifying apparatus 102; and is applied to a storage apparatus, a printer, a switch, etc. For example, when the host bus driver verifying apparatus 102 is applied to a storage apparatus, the host bus driver verifying apparatus 102 verifies the HBA driver operating in the higher-order system 101 for the storage apparatus. When the host bus driver verifying apparatus 102 is connected to any one of the storage apparatus, a printer, a switch, etc., the host bus driver verifying apparatus 102 may verify the HBA driver operating in the higher-order system 101 for the connected apparatus.

The HBA is an interface card mounted on the higher-order system 101. The HBA transmits and receives data to/from the connected apparatus. Depending on the connection form of the HBA, an FC, an Internet small computer system interface (iSCSI), a serial attached SCSI (SAS), etc., are present.

The HBA driver of the version number for which connection to the host bus driver verifying apparatus has been verified to be operating normally is to be used. When an HBA driver having a version number for which connection has not been verified is used, normal operation may not be achieved and a fault may occur.

Plural HBA drivers are often present associated with updating of the OS of the higher-order system or updating of the version of the OS, addition of functions or fault correction of the HBA by the vendor, etc. For example, the number of HBA drivers whose normal operations are verified differs for each model of the apparatus connected to the HBA or for the version number of the firmware of the apparatus connected to the HBA and therefore, plural drivers are present.

A procedure for verifying whether a driver is the driver of an HBA whose operation is verified to be normal may be, for example, a procedure according to which the manager of the higher-order system including the HBA views support information of the apparatus connected to the HBA to check whether the driver of the set HBA is valid. When the driver is different from the driver of the set HBA, the manager of the high-order system obtains the driver having the version number to be set, from a website, etc. of the vendor of the apparatus connected to the HBA, and installs the obtained driver. In general, an environment in which the apparatus is installed that is connected to the HBA is often isolated from the outside and therefore, the manager needs to check the information concerning the operation environment of the higher-order system and concerning the apparatus connected to the HBA, obtain the driver for the HBA, and prepare the driver in advance.

The above procedure requires work steps executed by the manager. Know-how is also required for the manager to select a proper driver. The manager may make an error when checking whether the set HBA driver is valid if the manager is busy or the manager does not pay sufficient attention, etc. and therefore, the manager may use the driver attached to the HBA or the driver already incorporated in the OS.

The host bus driver verifying apparatus 102 according to the present embodiment refers to the combination of the OS, the HBA, and the driver of the higher-order system whose operations are guaranteed to be normal, and verifies the HBA driver based on the OS and the HBA of the higher-order system 101. Thereby, the host bus driver verifying apparatus 102, in the verification thereof, does not need to distinguish the combinations from each other concerning the HBA-connected apparatus. The amount of information to be stored concerning the proper HBA driver can be reduced by the amount corresponding to the unnecessary distinguishing of the combinations, and the amount of the processing necessary for the searching for the information concerning the proper HBA driver can be reduced. Therefore, the verification can be executed efficiently.

In the example depicted in FIG. 1, it is assumed that the higher-order system 101 has an HBA driver 104 set therein as the HBA driver attached to be used for the HBA 103.

The host bus driver verifying apparatus 102 preliminarily stores correspondence relation information 111 that correlates the type of OS, the type of HBA, and the type of HBA driver that operates on the higher-order system and whose operations are guaranteed to be normal. It is assumed that the type of OS in this embodiment is distinguished based on the name of the OS and the version number thereof. For example, such types are different from each other as an “OS-A” whose OS name is “OS-A” and whose version number is “v1.0.0” and an “OS-A” whose version number is “v1.1.0”. The type of HBA in this embodiment is distinguished based on the model name of the HBA. The type of HBA driver is distinguished based on the version number of the HBA driver.

The higher-order system 101 transmits the connection information 112 including information concerning the type of OS and the type of HBA 103 of the higher-order system 101, to the host bus driver verifying apparatus 102 through the HBA 103 as a verification request for the HBA driver 104. The type of HBA 103 may be included or the version number of the HBA driver to be verified may be included in the connection information 112 as the information concerning the type of HBA 103.

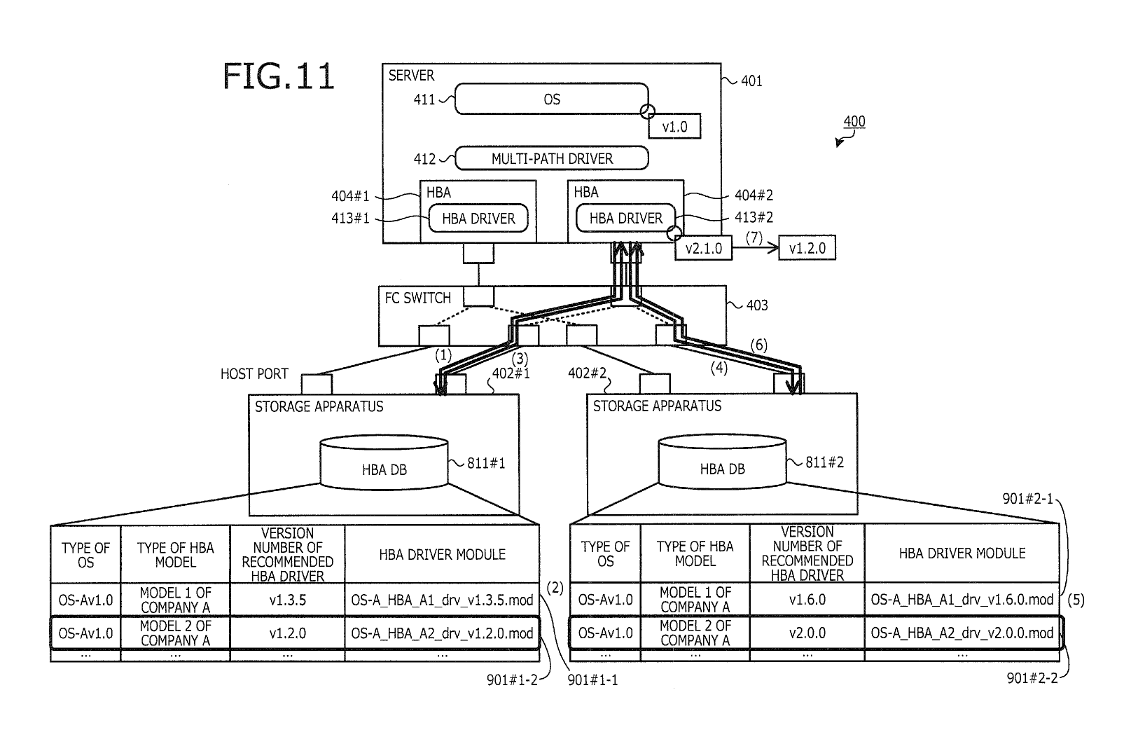

After receiving the connection information 112 through the HBA 103, the host bus driver verifying apparatus 102 obtains the type of HBA driver to be set in the higher-order system 101, based on the connection information 112 and the correspondence relation information 111. For example, the host bus driver verifying apparatus 102 obtains from the correspondence relation information 111, the type of HBA driver that corresponds to the type of OS and the type of HBA in the connection information 112, as the type of HBA driver to be set in the higher-order system 101. A specific obtaining method therefor will be described later with reference to FIG. 11.

The host bus driver verifying apparatus 102 verifies whether the acquired HBA type matches the HBA driver type set in the higher-order system 101. When the host bus driver verifying apparatus 102 verifies that the two types match, the host bus driver verifying apparatus 102 determines as a result of the verification that the normal HBA driver is set. On the other hand, when the host bus driver verifying apparatus 102 verifies that the two types differ from one another, the host bus driver verifying apparatus 102 determines as a result of the verification that an HBA driver is set whose operation is not guaranteed to be normal.

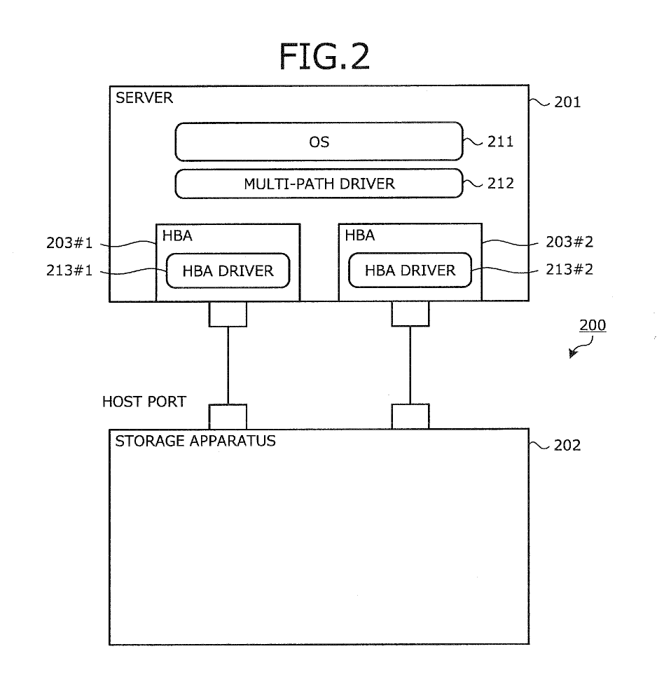

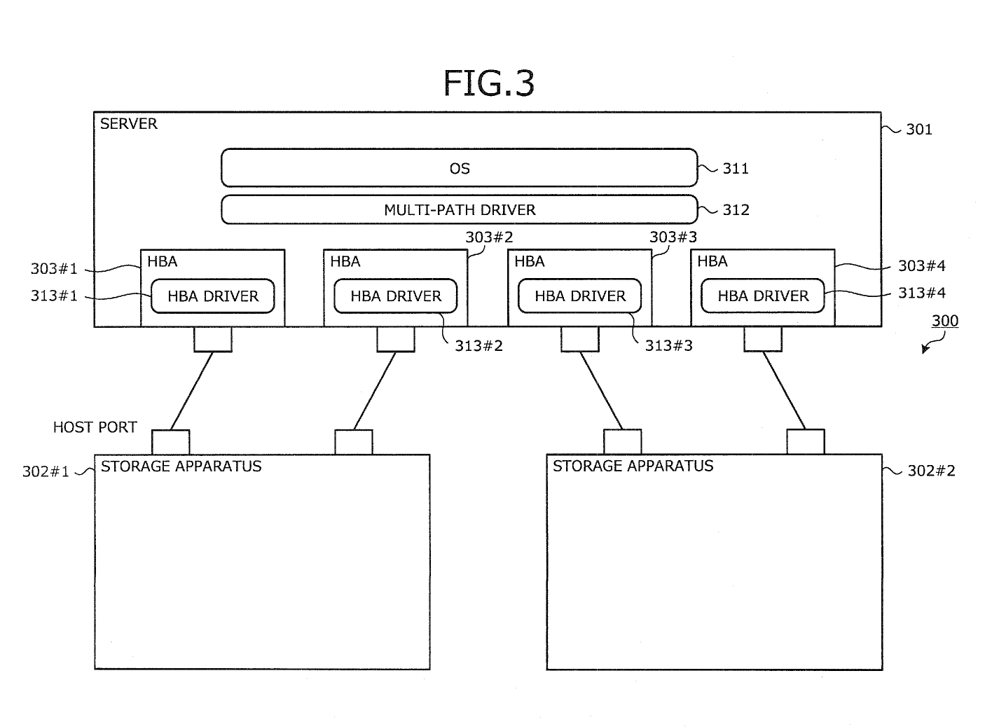

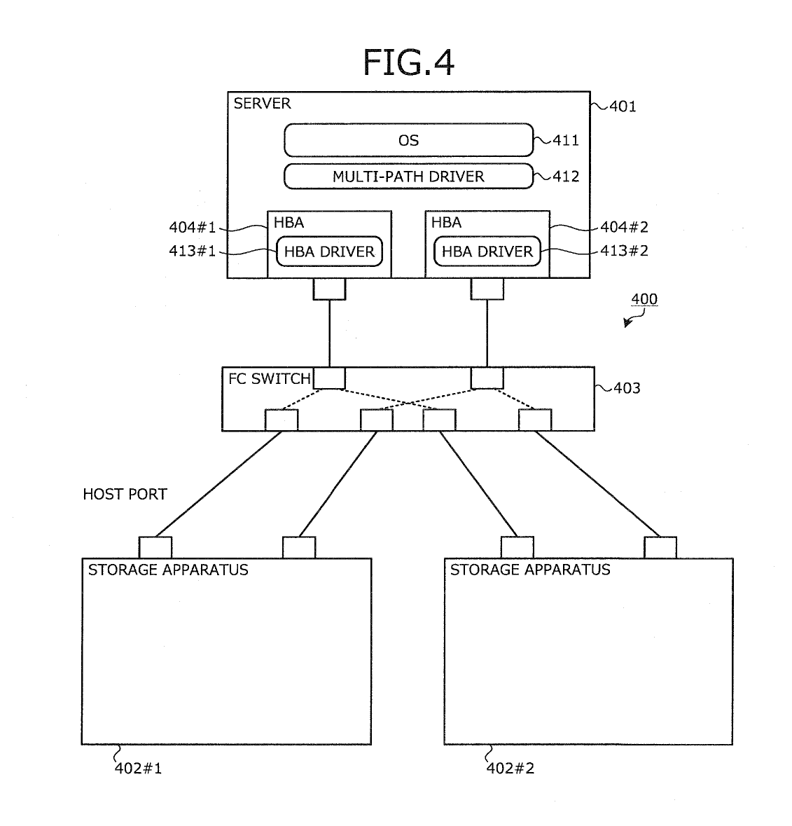

A first example will be described with reference to FIG. 2 as an example where the host bus verification system 100 is applied to a storage system. A second example will be described with reference to FIG. 3. A third example will be described with reference to FIG. 4. The storage system is a system that provides a user with a storage area retained by the storage apparatus. A server included in the storage system corresponds to the higher-order system 101. The storage apparatus included in the storage system corresponds to the host bus driver verifying apparatus 102.

FIG. 2 is an explanatory diagram of the first example of the storage system. A storage system 200 as the first example is a system having one server and one storage apparatus that are directly connected therein to each other. For example, the storage system 200 includes a server 201 and a storage apparatus 202. The server 201 and the storage apparatus 202 are connected to each other based on a host port.

The server 201 is an apparatus that provides the user with the functions of the storage system 200. The storage apparatus 202 is an apparatus including large-capacity storage areas. The storage areas included in the storage apparatus 202 include a user data area that has user data stored therein that is used by the user of the storage system 200, and a system area that is used to manage the storage system 200.

The server 201 includes two HBAs (203#1 and 203#2), and executes an OS 211, a multi-path driver 212, and HBA drivers 213#1 and 213#2, as software.

The OS 211 controls the overall server 201. The multi-path driver 212 is mounted on each of the plural HBAs in the server system and when plural paths are present between apparatuses connected to the plural HBAs and the server system, the multi-path driver 212 is software controlling the plural paths. The multi-path driver is software installed in the server system. For example, the multi-path driver determines which path of the plural paths is used when the server system is connected to the host bus adaptor. The HBA drivers 213#1 and 213#2 respectively control the HBAs 203#1 and 203#2.

FIG. 3 is an explanatory diagram of the second example of the storage system. A storage system 300 in the second example is a system having one server and two storage apparatuses directly connected therein to each other. For example, the storage system 300 includes a server 301 and storage apparatuses 302#1 and 302#2. The server 301 and the storage apparatuses 302#1 and 302#2 are connected to each other based on host ports.

The server 301 is an apparatus that provides the user with the functions of the storage system 300. The storage apparatuses 302#1 and 302#2 are apparatuses each including large-capacity storage areas and, a user data area and a system area.

The server 301 includes HBAs 303#1 to 303#4 as four HBAs. The HBAs 303#1 and 303#2 are connected to the storage apparatus 302#1. The HBAs 303#3 and 303#4 are connected to the storage apparatus 302#2. As described, the storage system 300 is an example where the one HBA is connected to the one storage apparatus.

The server 301 executes, as software, an OS 311, a multi-path driver 312, and HBA drivers 313#1 to 313#4. The OS 311 controls the server 301 overall. The HBA driver 313#1 controls the HBA 303#1. The HBA driver 313#2 controls the HBA 303#2. The HBA driver 313#3 controls the HBA 303#3. The HBA driver 313#4 controls the HBA 303#4.

FIG. 4 is an explanatory diagram of the third example of the storage system. A storage system 400 in the third example includes one server and two storage apparatuses that are connected to each other through an FC switch. For example, the storage system 400 includes a server 401, storage apparatuses 402#1 and 402#2, and an FC switch 403. The server 401 and the storage apparatuses 402#1 and 402#2, and the FC switch 403 are connected to each other based on host ports.

The server 401 is an apparatus providing the user with the functions of the storage system 400. The storage apparatuses 402#1 and 402#2 are apparatuses each including large-capacity storage areas and, a user data area and a system area.

The server 401 includes HBAs 404#1 and 404#2 as two HBAs. The HBAs 404#1 and 404#2 are respectively connected to the storage apparatuses 402#1 and 402#2. In this manner, the storage system 400 is an example where the one HBA is connected to the two storage apparatuses.

The server 401 executes, as software, an OS 411, a multi-path driver 412, and HBA drivers 413#1 and 413#2. The OS 411 controls the server 401 overall. The HBA driver 413#1 controls the HBA 404#1. The HBA driver 413#2 controls the HBA 404#2.

This embodiment is applicable to any one of the storage systems 200, 300, and 400. In the description below, the storage system 400 in the third example will be taken as an example.

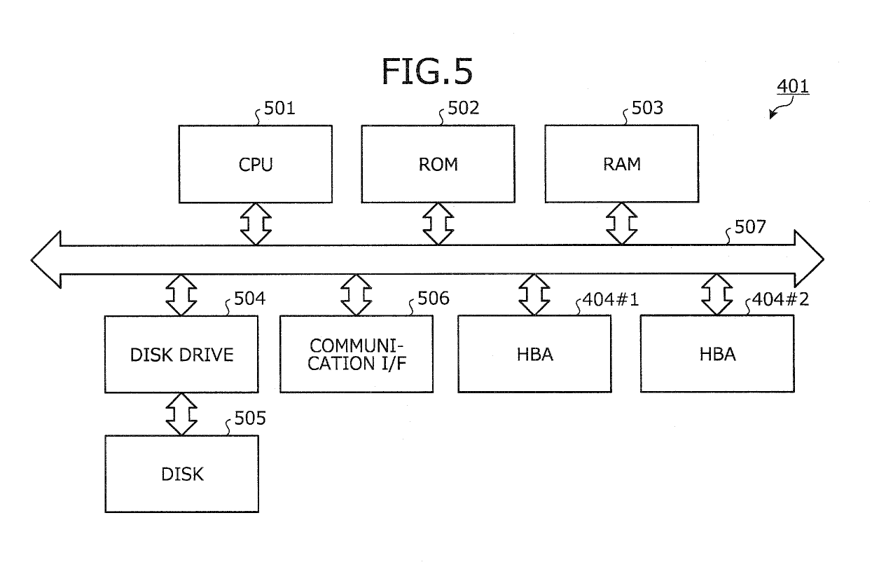

FIG. 5 is a block diagram of an example of a hardware configuration of the server. In FIG. 5, the server 401 includes a central processing unit (CPU) 501, read-only memory (ROM) 502, random access memory (RAM) 503, a disk drive 504 and a disk 505, a communication interface (I/F) 506, the HBA 404#1, and the HBA 404#2, respectively connected by a bus 507.

The CPU 501 is a computation processing apparatus that governs overall control of the server 401. The ROM 502 is non-volatile memory that stores programs such as a boot program. The RAM 503 is volatile memory that is used as a work area of the CPU 501.

The disk drive 504, under the control of the CPU 501, controls the reading and writing of data with respect to the disk 505. A magnetic disk drive, a solid state drive, and the like may be adopted as the disk drive 504. The disk 505 is non-volatile memory that stores the data written thereto under the control of the disk drive 504. For example, when the disk drive 504 is a magnetic disk drive, a magnetic disk may be adopted as the disk 505. Further, when the disk drive 504 is a solid state drive, semiconductor memory may be adopted as the disk 505.

The communication I/F 506 is a control apparatus that administers an internal interface with the network and control the input and output of data with respect to other apparatuses. For example, the communication I/F 506 is connected, through a communication line, to an apparatus that is operated by the user of the storage system 400. A modem or a LAN adapter may be adopted as the communication I/F 506.

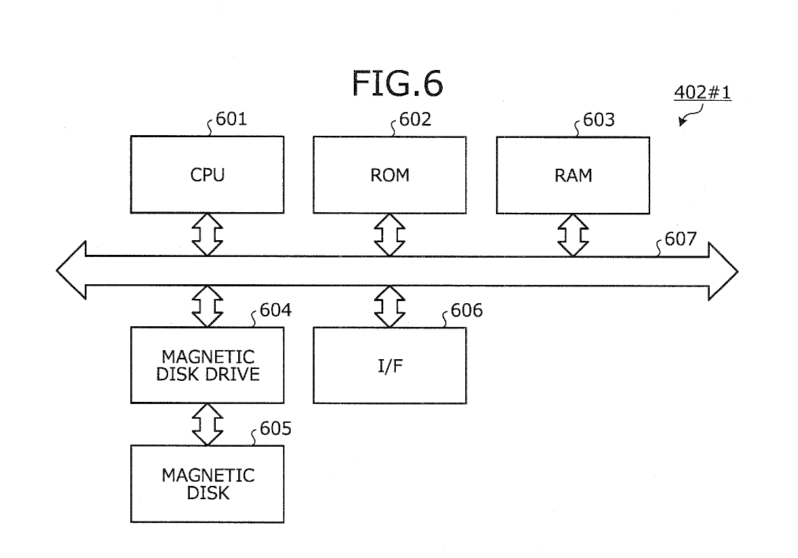

If directly operated by the manager of the storage system 400, the server 401 further includes a keyboard and/or a mouse. In FIG. 6, a hardware configuration example of the storage apparatus will be described taking the storage apparatus 402#1 as an example. The storage apparatuses 402#2 and 402#1 have the same hardware configuration.

FIG. 6 is a block diagram of an example of a hardware configuration of the storage apparatus. In FIG. 6, a hardware configuration example will be described taking the storage apparatus 402#1 as an example. The storage apparatuses 402#2 and 402#1 have the same configuration. In FIG. 6, the storage apparatus 402#1 includes a CPU 601, ROM 602, RAM 603, a magnetic disk drive 604 and a magnetic disk 605, and an I/F 606, respectively connected by a bus 607.

The CPU 601 is a computation processing apparatus that governs overall control of the storage apparatus 402#1. The ROM 602 is non-volatile memory that stores programs such as a boot program. The RAM 603 is volatile memory that is used as a work area of the CPU 601.

The magnetic disk drive 604, under the control of the CPU 601, controls the reading and writing of data with respect to the magnetic disk 605. The magnetic disk 605 is an apparatus storing to a disk to which a magnetic material has been applied, data that has been written thereto under the control of the magnetic disk drive 604. The I/F 606 is a control apparatus that controls the input and output of data from the server 401, via a host port.

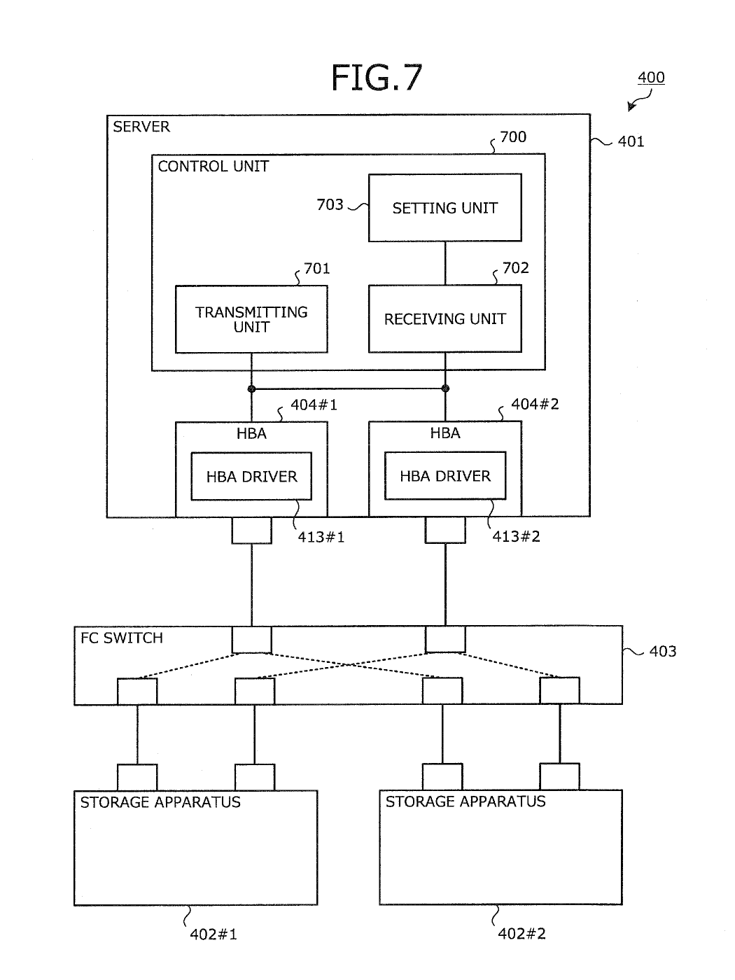

FIG. 7 is a block diagram of an example of a functional configuration of the server. The server 401 includes a control unit 700. The control unit 700 includes a transmitting unit 701, a receiving unit 702, and a setting unit 703; is a function included in a multi-path driver 412; and is implemented by executing on the CPU 501, a program stored in a storing apparatus. The storing apparatus is, for example, the ROM 502, the RAM 503, the disk 505, etc. depicted in FIG. 5. The result of processing by each unit is stored to the RAM 503, the disk 505, etc. of the server 401.

The transmitting unit 701 transmits a verification request for the HBA driver 413 to the storage apparatus 402. The verification request for the HBA driver 413 will hereinafter be referred to as “HBA inquiry command”. The HBA inquiry command includes the type of OS, the type of HBA model, and the version number of the HBA driver 413 to be verified. Details of the HBA inquiry command will be described later with reference to FIG. 11. For example, the transmitting unit 701 transmits the HBA inquiry command for the HBA driver 413#1 to the storage apparatuses 402#1 and 402#2 connected to the HBA driver 413#1.

The transmitting unit 701 transmits the HBA inquiry command, whereby the receiving unit 702 receives the verification result from the storage apparatus 402. The verification result will hereinafter be referred to as “HBA inquiry command response”. The HBA inquiry command response includes return code indicating whether the verification result is correct. When the return code indicates that the verification result is incorrect, the HBA inquiry command response may include the type of the HBA driver 413 to be set and the HBA driver 413 to be set. Details of the HBA inquiry command response will be described later with reference to FIG. 11. For example, the receiving unit 702 receives the HBA inquiry command responses from the storage apparatuses 402#1 and 402#2.

The setting unit 703 sets the HBA driver 413 based on the HBA inquiry command response received by the receiving unit 702. For example, it is assumed that the HBA inquiry command response includes a version number as the type of the HBA driver 413 to be set. In this case, the setting unit 703 sets the HBA driver 413 corresponding to the version number by installing the HBA driver 413 corresponding to the version number. For example, to obtain the HBA driver 413 corresponding to the version number, through a network, the setting unit 703 may connect to an apparatus storing support information concerning the HBA driver 413 and obtain the HBA driver 413 corresponding to the version number. When the HBA inquiry command response includes the HBA driver 413 to be set, the setting unit 703 may acquire from the HBA inquiry command response, the HBA driver 413 to be set.

It is assumed that one HBA 404#1 is connected to plural storage apparatuses 402 and the receiving unit 702 receives plural HBA inquiry command responses. In this case, when the version number of the HBA driver 413 to be set in each of the HBA inquiry command responses differs from one another, the setting unit 703 sets the driver whose version number is the smallest among the different version numbers. A setting example will be described later with reference to FIG. 11. Although the version number is generally represented by a numerical value, the version number may include characters such as alphabet letters. When such a character is included, for example, for the character portion thereof, the setting unit 703 may determine the magnitude of each of the different version numbers based on the dictionary order to set the driver having the smallest version number. For example, when two drivers 413 are present having the version numbers “v1.0a” and “v1.0b”, the setting unit 703 sets the HBA driver 413 having the version number “v1.0a”.

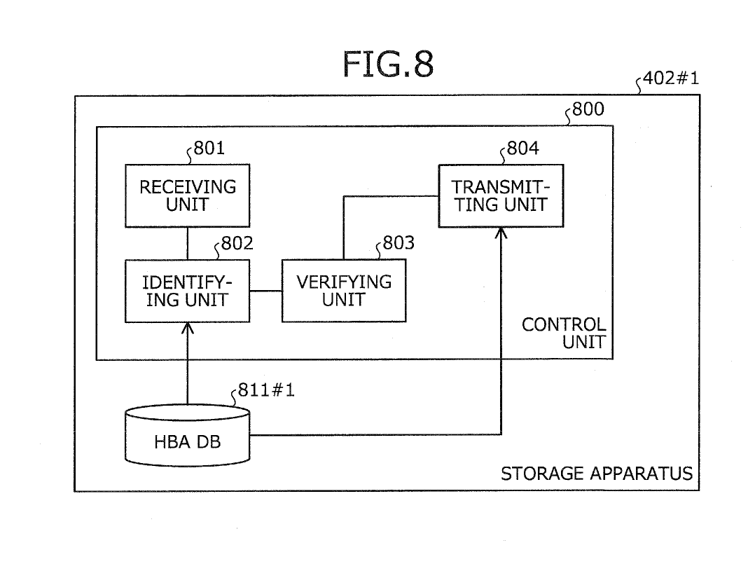

FIG. 8 is a block diagram of an example of functional configuration of the storage apparatus. In FIG. 8, an example of the functional configuration will be described taking the storage apparatus 402#1 as an example. The storage apparatus 402#2 also has the same functional configuration as that of the storage apparatus 402#1. The storage apparatus 402 includes a control unit 800. The control unit 800 includes a receiving unit 801, an identifying unit 802, a verifying unit 803, and a transmitting unit 804. Functions of the control unit 800 are implemented by executing on a CPU 601, a program stored in a storing apparatus. The storing apparatus is, for example, a ROM 602, a RAM 603, a magnetic disk 605, etc. depicted in FIG. 6. The result of processing by each of the units is stored to the RAM 603, the magnetic disk 605, etc. of the storage apparatus 402#1.

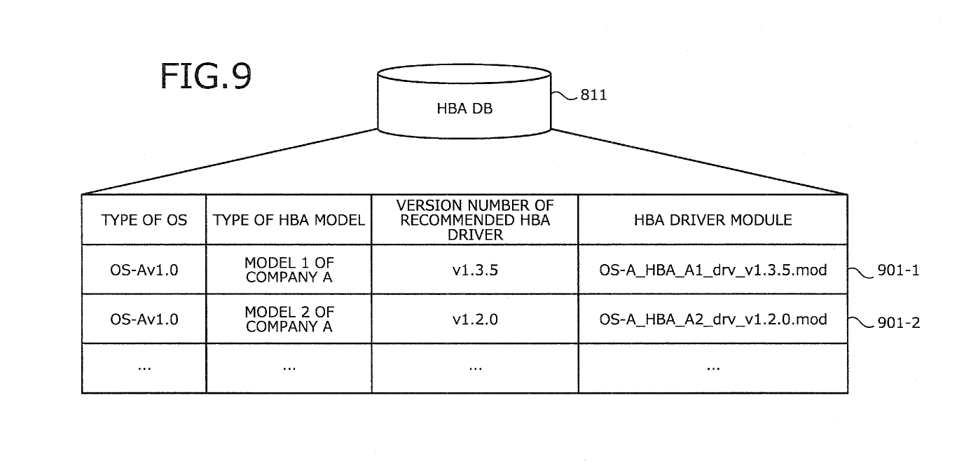

The storage apparatus 402#1 can access an HBA DB 811#1. The HBA DB 811#1 is stored in a system area of the magnetic disk 605. The contents of the HBA DB 811 corresponds to the correspondence relation information 111 described with reference to FIG. 1. Details of the contents of the HBA DB 811 will be described later with reference to FIG. 9.

The receiving unit 801 receives the HBA inquiry command. The HBA inquiry command includes the connection information 112 described with reference to FIG. 1.

The identifying unit 802 identifies the type of HBA driver 413 to be set in the server 401, based on the connection information 112 included in the HBA inquiry command received by the receiving unit 801 and the correspondence relation information 111 included in the HBA DB 811. For example, the identifying unit 802 detects from the correspondence relation information 111, a record whose type of OS and type of HBA are same as those included in the connection information 111. The identifying unit 802 identifies the type of HBA driver 413 in the detected record as the type of HBA driver 413 to be set in the server 401.

The verifying unit 803 verifies whether the type of HBA driver 413 identified by the identifying unit 802 matches the type of HBA driver 413 set in the server 401. For example, when the verifying unit 803 verifies that the version number of the identified HBA driver 413 and the version number of the HBA driver 413 set in the server 401 match one another, the verifying unit 803 determines, as a verification result, that the normal HBA driver is set.

When the verifying unit 803 verifies that the type of the HBA driver 413 identified by the identifying unit 802 is different from the type of the HBA driver 413 set in the server 401, the transmitting unit 804 transmits to the server 401, the HBA driver 413 to be set in the server 401.

The control unit 800 may download from an external apparatus, the HBA driver 413 that corresponds to the type of HBA driver and may store the downloaded HBA driver 413 in the HBA DB 811 correlating the downloaded HBA driver 413 with the type of the HBA driver 413. The external apparatus is an external apparatus external to the storage system 400 and is, for example, a server having the HBA driver 413 stored therein by the management of the vendor of the HBA driver 413.

FIG. 9 is an explanatory diagram of an example of the contents of the HBA DB. The HBA DB 811 depicted in FIG. 9 includes records 901-1 and 901-2. The HBA DB 811 has four fields for the type of OS, the type of HBA model, the version number of the recommended HBA driver, and the HBA driver module.

The type of OS field stores the type of OS for which the HBA driver module is installed in the server for a case where it can be verified that the storage apparatus including the HBA DB 811 operates normally. The type of OS is distinguished based on the name and the version number of the OS. For example, for an OS, an OS whose version number is 1 and an OS whose version number is 2 are types of the OS that are different from one another.

The type of HBA model field stores the type of HBA model for a case where it can be verified that the storage apparatus including the HBA DB 811 operates normally. The version number of the recommended HBA driver field stores the version number of the HBA driver included in the server for a case where it can be verified that the storage apparatus including the HBA DB 811 operates normally. The HBA driver module field stores the HBA driver 413 for a case where it can be verified that the storage apparatus including the HBA DB 811 operates normally. In the description below, the program code of the HBA driver 413 may be referred to as “HBA driver module”. The HBA driver module field may store the name of a file having the HBA driver module stored therein and the file path, stored therein.

For example, the record 901-1 indicates that the type of OS installed in the server is “OS-A v1.0” and the type of HBA model included in the server is “model 1 of company A” for a case where it can be verified that the storage apparatus including the HBA DB 811 operates normally. The record 901-1 also indicates that the version number of the HBA driver is “v1.3.5” for a case where it can be verified that the storage apparatus including the HBA DB 811 operates normally. The record 901-1 also indicates that the physical entity of the HBA driver module is “OS-A_HBA_A1_drv_v1.3.5.mod” for a case where it can be verified that the storage apparatus including the HBA DB 811 operates normally.

As described, the HBA DB 811 includes an HBA driver module for each combination of the type of OS of the server and the type of HBA and therefore, the data amount becomes an unignorable amount. Therefore, when the HBA DB 811 is disposed in an area normally accessible by the server 401, the user resources are pressured. Therefore, the storage apparatus 402 disposes the HBA DB 811 not in the use area typically accessible by the server 401 but in the system area. The multi-path driver 412 accesses the system area typically not accessible by the server 401 and therefore, uses a special interface specific thereto for the communication with the storage apparatus 402.

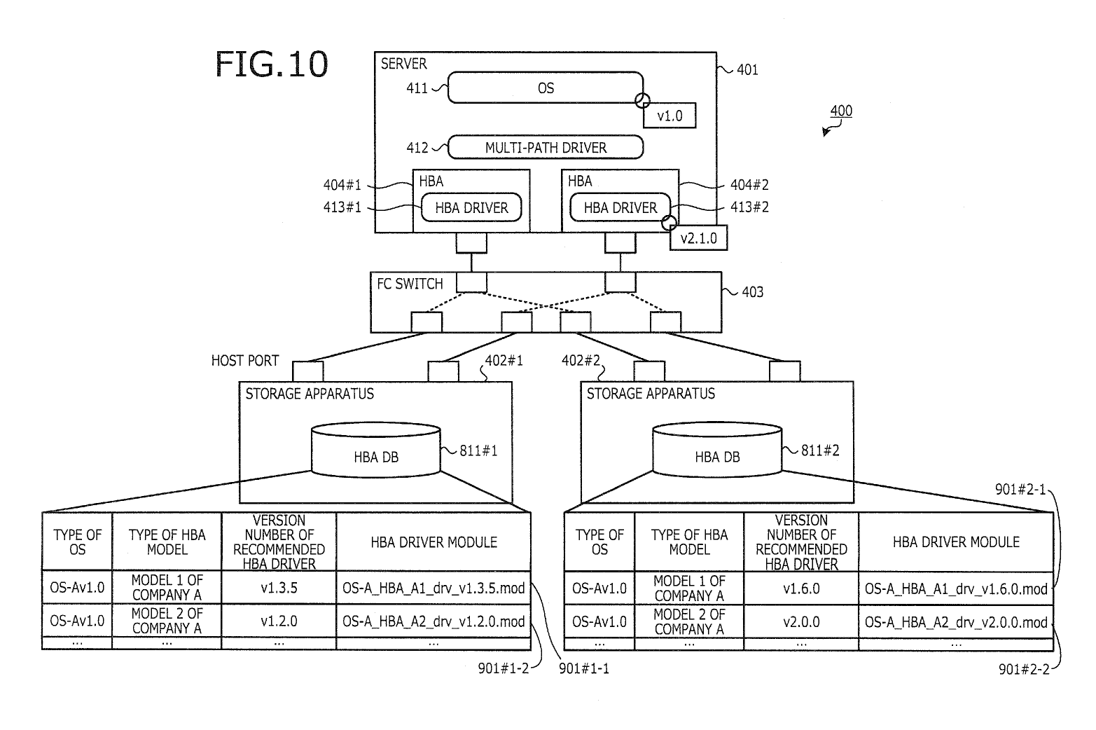

An example of operation for a verification process of the HBA driver will be described with reference to FIG. 10. The verification process of the HBA driver is a process to be executed before the multi-path driver 412 constructs multiple paths. At a SAN boot time point, the multi-path driver 412 still cannot operate and therefore, no verification process for the HBA driver is executed. At the SAN boot time point, when the version number is not the version number of the HBA driver that normally operates whereby a problem arises, the starting up of the storage system 400 is not completed. In this case, the manager of the storage system 400 rechecks the various settings including the version number of the HBA driver and therefore, the normal HBA driver is finally used. When a completely inoperable HBA driver is used, the server 401 cannot access the storage apparatus 402. In this case, similar to a case of the SAN boot, the manager of the storage system 400 rechecks the various settings including the version number of the HBA driver and therefore, the normal HBA driver is finally used.

FIG. 10 is an explanatory diagram (Part I) of an operation example of the verification process for the HBA driver. The storage system 400 depicted in FIG. 10 executes the verification for the HBA driver 413#2 that controls the HBA 404#2. The state of the storage system 400 before the verification will be described with reference to FIG. 10.

The server 401 executes an OS-A whose version number is v1.0, and executes the HBA driver 413#2 whose version number is v2.1.0, as the HBA driver installed in the server 401. The type of model of the HBA 404#2 is “model 2 of Company A”.

The HBA DB 811#1 of the storage apparatus 402#1 stores records 901#1-1 and 901#1-2. The HBA DB 811#2 of the storage apparatus 402#2 stores records 901#2-1 and 901#2-2.

FIG. 11 is an explanatory diagram (Part II) of the operation example of the verification process for the HBA driver. The multi-path driver 412 verifies whether the HBA driver 413#2 whose version number is v2.1.0 is a driver whose operation is guaranteed to be normal. When the multi-path driver 412 executes the verification process for the HBA driver, the multi-path driver 412 sets the version number of the recommended HBA driver to be “0”. When the version number of the recommended HBA driver is “0”, this indicates the state where the HBA inquiry command response for the first session is not yet received and, when the version number of the recommended HBA driver is a number other than “0”, this indicates the state where the HBA inquiry command for the first session is already received.

The multi-path driver 412 issues an HBA inquiry command to the storage apparatus 402#1 as a process (1) in FIG. 11. The HBA inquiry command is a command to inquire whether the HBA driver represented by the version number included in the HBA inquiry command is a driver whose operation is guaranteed to be normal. The HBA inquiry command includes the type of OS, the type of HBA model, and the version number of the HBA driver to be verified. The HBA inquiry command issued in the process (1) of FIG. 11 includes “OS-Av1.0” as the type of the OS, “model 2 of company A” as the type of HBA model, and “v2.1.0” as the version number of the HBA driver to be verified.

After receiving the HBA inquiry command, the storage apparatus 402#1 searches the HBA DB 811#1 using, as keys, the OS name and the HBA model name in the HBA inquiry command, as a process (2) in FIG. 11. In this case, the storage apparatus 402#1 detects a record 901#1-2. The storage apparatus 402#1 determines whether the value of the version number of the HBA driver in the HBA inquiry command and the value of the version number of the recommended HBA driver in the detected record match. In the example of the process (2) in FIG. 11, the version number of the HBA driver in the HBA inquiry command is “v2.1.0” and the version number of the recommended HBA driver in the detected record is “v1.2.0” and therefore, the storage apparatus 402#1 determines that the version numbers of the drivers do not match.

Because the version numbers of the drivers do not match, the storage apparatus 402#1 transmits an HBA inquiry command response to the server 401, as a process (3) in FIG. 11. The HBA inquiry command response includes the return code, the version number of a notified recommended HBA driver, and a notified recommended HBA driver. The return code stores any one of the following three identifiers. The first identifier is “0” indicating that the value of the version number of the HBA driver in the HBA inquiry command and the value of the version number of the recommended HBA driver of the detected record match. The second identifier is “4” indicating that the value of the version number of the HBA driver in the HBA inquiry command and the value of the version number of the recommended HBA driver in the detected record differ. The third identifier is “8” indicating that no record is present in the HBA DB 811#1, that corresponds to the type of OS and the type of HBA model in the HBA inquiry command.

The version number of the notified recommended HBA driver is the version number of the HBA driver whose normal operation is guaranteed, notified of from the storage apparatus 402#1. The notified recommended HBA driver is the module of the recommended HBA driver whose normal operation is guaranteed, notified of from the storage apparatus 402#1.

The HBA inquiry command response transmitted in the process (3) of FIG. 11 includes “4” as the return code, “v1.2.0” as the version number of the notified recommended HBA driver, and a module whose name is “OS-A_HBA_A2_drv_v1.2.0.mod”.

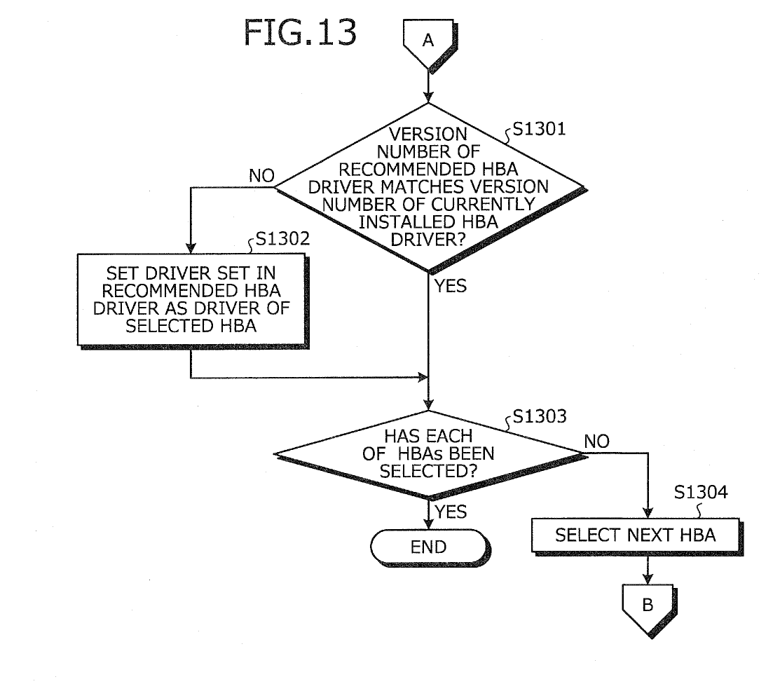

After receiving the HBA inquiry command response, the multi-path driver 412 executes a process corresponding to the return code included in the response. The process corresponding to the return code will be described with reference to FIG. 13. In the process (3) of FIG. 11, the return code included in the response is “4” and is the HBA inquiry command response for the first session and therefore, the multi-path driver 412 sets the version number of the HBA driver in the HBA inquiry command to be issued thereafter to be “v1.2.0”, and sets the version number of the recommended HBA driver to be “v1.2.0”. For the HBA inquiry command responses in the second or a later session, the description will be made concurrently with the description for a process (6) of FIG. 11.

The multi-path driver 412 issues the HBA inquiry command to the storage apparatus 402#2 as a process (4) of FIG. 11. The HBA inquiry command issued in the process (4) of FIG. 11 includes “OS-Av1.0” as the type of OS, “model 2 of company A” as the type of HBA model, and “v1.2.0” as the version number of the HBA driver.

After receiving the HBA inquiry command, the storage apparatus 402#2 searches the HBA DB 811#2 using, as keys, the OS name and the HBA model name in the HBA inquiry command, as a process (5) of FIG. 11. In this case, the storage apparatus 402#2 detects a record 901#2-2. The storage apparatus 402#2 determines whether the value of the version number of the HBA driver in the HBA inquiry command and the value of the version number of the recommended HBA driver in the detected record match. In the example of the process (5) of FIG. 11, the version number of the HBA driver in the HBA inquiry command is “v1.2.0” and the version number of the recommended HBA driver in the detected record is “v2.0.0” and therefore, the storage apparatus 402#2 determines that the version numbers of the drivers do not match.

Because the storage apparatus 402#2 determines that the version numbers of the drivers do not match, the storage apparatus 402#2 transmits the HBA inquiry command response to the server 401, as the process (6) in FIG. 11. The HBA inquiry command response transmitted in the process (6) of FIG. 11 includes driver modules having file names of “4”, “v2.0.0”, and “OS-A_HBA_A2_drv_v2.0.0.mod”.

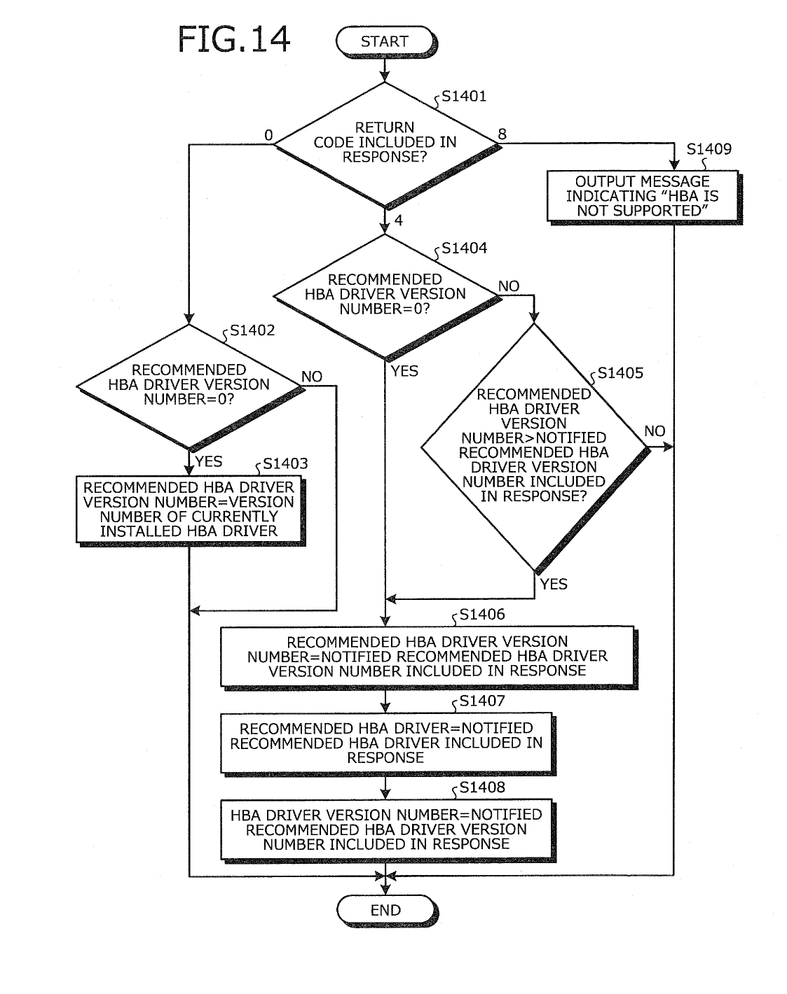

After receiving the HBA inquiry command response, the multi-path driver 412 executes a process corresponding to the return code included in the response. The process corresponding to the return code will be described with reference to FIG. 14. In the process (6) of FIG. 11, the return code included in the response is “4” and this indicates that this response is an HBA inquiry command response in the second or a later session. Therefore, the multi-path driver 412 identifies the version number of the HBA driver that is normally usable commonly to all the storage apparatuses 402 that transmit responses. The firmware of the storage apparatus 402 is normally upward compatible for an HBA driver. The “upward compatibility” means that a product such as software of a later version is compatible with a product of a lower version, in terms of function and performance. For example, the storage apparatus 402 whose normal operation is guaranteed for the HBA driver having the HBA driver version number that is “v2.0.0”, also normally operates for the HBA driver having the version number that is “v2.0.0” or lower.

In this embodiment, the multi-path driver 412 uses the lowest-order HBA driver version number among the recommended HBA driver version numbers included in the HBA inquiry commands, making use of upward compatibility. For example, the multi-path driver 412 compares the magnitude between the version number of the recommended HBA driver and the version number of the notified recommended HBA driver.

If the multi-path driver 412 determines that the version number of the recommended HBA driver is larger than that of the notified recommended HBA driver, this indicates that the version number with which the normal operation of the storage apparatus 402 responding before the current time point is guaranteed, is of a higher order than that of the version number with which the normal operation of the storage apparatus 402 responding at the current time point is guaranteed. The storage apparatus 402 responding before the current time point also normally operates even with the notified recommended HBA driver version number consequent to upward compatibility. Therefore, the multi-path driver 412 changes the recommended HBA driver version number to the notified recommended HBA driver version number to cause the storage apparatus 402 responding before the current time point to normally operate and to cause the storage apparatus 402 responding at the current time point to also normally operate.

If the multi-path driver 412 determines that the version number of the recommended HBA driver is smaller than that of the notified recommended HBA driver, this indicates that the version number with which the normal operation of the storage apparatus 402 responding before the current time point is guaranteed, is of a lower order than that of the version number with which the normal operation of the storage apparatus 402 responding at the current time point is guaranteed. The storage apparatus 402 responding at the current time point also normally operates even with the recommended HBA driver version number consequent to upward compatibility. Therefore, the multi-path driver 412 does not change the recommended HBA driver version number to cause the storage apparatus 402 responding at the current time point to normally operate and to cause the storage apparatus 402 responding before the current time point to also normally operate.

In the process (6) of FIG. 11, the recommended HBA driver version number is “v1.2.0” and the notified recommended HBA driver version number is “v2.0.0” and therefore, the multi-path driver 412 does not change the value of the recommended HBA driver version number.

When the multi-path driver 412 receives the responses from all the storage apparatuses 402, the multi-path driver 412 determines as a process (7) in FIG. 11 whether the version number of the recommended HBA driver matches the version number of the currently installed HBA driver. If the multi-path driver 412 determines that the version numbers do not match, the multi-path driver 412 installs the HBA driver corresponding to the recommended HBA driver version number. In the process (7) of FIG. 11, the recommended HBA driver version number is “v1.2.0” and the version number of the currently installed HBA driver is “v2.1.0” and therefore, the multi-path driver 412 installs the HBA driver of “v1.2.0”.

Thereby, the storage system 400 can cause the HBA 404#2 to operate using the HBA driver whose version number is “v1.2.0” and with which the normal operation of the storage apparatuses 402#1 and 402#2 is guaranteed.

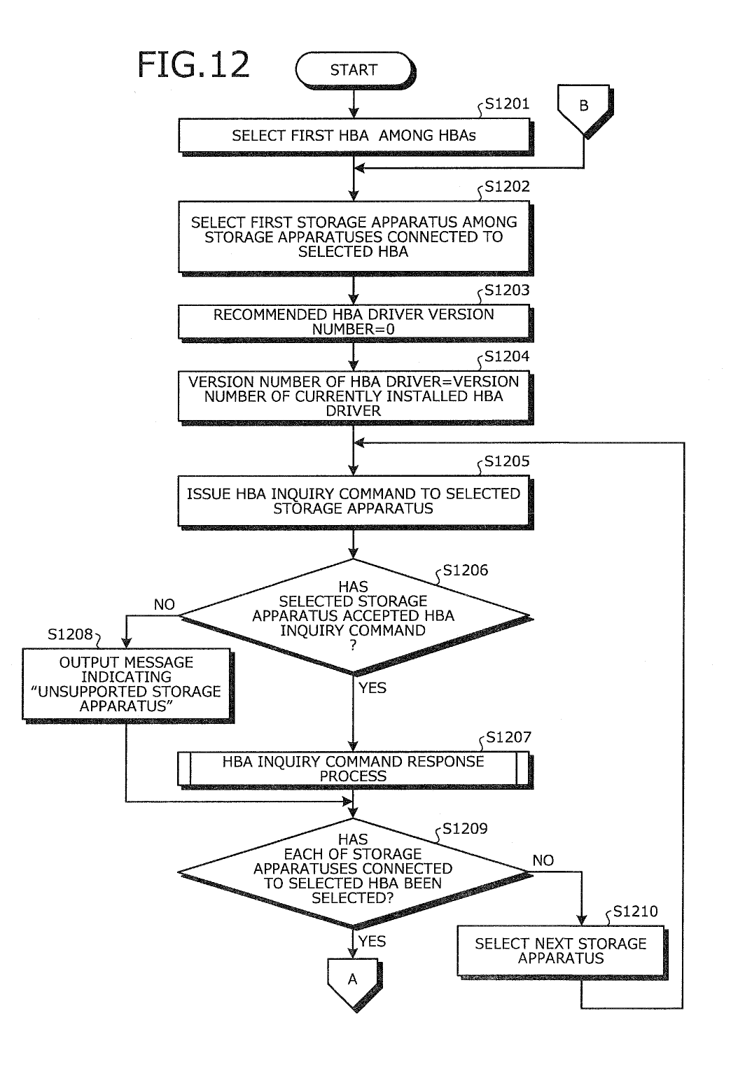

Flowcharts of an operation executed by the storage system 400 will be described with reference to FIGS. 12 to 15.

FIG. 12 is a flowchart (Part I) of an example of a procedure for an HBA driver verification process executed by the server. FIG. 13 is a flowchart (Part II) of the example of the procedure for the HBA driver verification process executed by the server. The HBA driver verification process executed by the server is a process of executing the verification for the HBA driver 413 installed in the server 401.

The multi-path driver 412 selects a first HBA 404 among the plural HBAs 404 (step S1201). After the operation at step S1201 comes to an end or after the operation at step S1304 comes to an end, the multi-path driver 412 selects the first storage apparatus 402 among the plural storage apparatuses 402 connected to the selected HBA 404 (step S1202), sets the recommended HBA driver version number to be “0” (step S1203), and sets the version number of the HBA driver to be the version number of the currently installed HBA driver (step S1204).

The multi-path driver 412 issues an HBA inquiry command to the selected storage apparatus 402 (step S1205) and determines whether the selected storage apparatus 402 accepts the HBA inquiry command (step S1206). If the multi-path driver 412 determines that the selected storage apparatus 402 has accepted the HBA inquiry command (step S1206: YES), the multi-path driver 412 executes an HBA inquiry command response process (step S1207). The HBA inquiry command response process will be described later with reference to FIG. 14.

If the multi-path driver 412 determines that the selected storage apparatus 402 has denied the HBA inquiry command (step S1206: NO), the multi-path driver 412 outputs a message indicating “unsupported storage apparatus” (step S1208). In the case of “step S1206: NO”, for example, the selected storage apparatus does not support the HBA driver verification process. In the case of “step S1206: NO”, the multi-path driver 412 does not need to execute the operation at step S1208.

After the operation at step S1207 or step S1208 comes to an end, the multi-path driver 412 determines whether each of the storage apparatuses 402 connected to the selected HBA 404 has been selected (step S1209). If the multi-path driver 412 determines that a storage apparatus 402 connected to the selected HBA 404 has not yet been selected (step S1209: NO), the multi-path driver 412 selects the next storage apparatus (step S1210) and proceeds to the operation at step S1205.

If the multi-path driver 412 determines that each of the storage apparatuses connected to the selected HBA 404 has been selected (step S1209: YES), the multi-path driver 412 proceeds to the operation at step S1301 depicted in FIG. 13.

In the case of “step S1209: YES”, the multi-path driver 412 determines whether the version number of the recommended HBA driver matches the version number of the currently installed HBA driver (step S1301). If the multi-path driver 412 determines that the version number of the recommended HBA driver is different from the version number of the currently installed HBA driver (step S1301: NO), the multi-path driver 412 sets the driver set in the recommended HBA driver as the driver of the selected HBA 404 (step S1302). For the operation at step S1302, for example, the multi-path driver 412 installs the module of the HBA driver transmitted together with the recommended HBA driver version number and, thereby, sets this HBA driver as the driver for the selected HBA 404.

After the operation at step S1302 comes to an end or if the multi-path driver 412 determines that the version number of the recommended HBA driver matches the version number of the currently installed HBA driver (step S1301: YES), the multi-path driver 412 determines whether each of the HBAs 404 has been selected (step S1303). If the multi-path driver 412 determines that an HBA 404 remains unselected (step S1303: NO), the multi-path driver 412 selects the next HBA (step S1304), and proceeds to the operation at step S1202.

If the multi-path driver 412 determines that each of the HBAs 404 has been selected (step S1303: YES), the multi-path driver 412 causes the HBA driver verification process executed by the server to come to an end. The execution of the HBA driver verification process by the server enables the storage system 400 to verify the HBA driver 413 installed in the server 401. The storage system 400 can set the HBA driver 413 for which normal operation is guaranteed for all the storage apparatuses 402 connected to the HBA 404.

FIG. 14 is a flowchart of an example of a procedure for an HBA inquiry command response process. The HBA inquiry command response process is a process executed for the response by the storage apparatus 402. When the multi-path driver 412 receives the HBA inquiry command response from the storage apparatus 402, the multi-path driver 412 determines which one of the following identifiers the return code included in the response matches (step S1401). The identifiers are “0”, “4”, and “8”.

If the multi-path driver 412 determines that the return code included in the response indicates “0” (step S1401: 0), the multi-path driver 412 determines whether the recommended HBA driver version number is “0” (step S1402). If the multi-path driver 412 determines that the recommended HBA driver version number is “0” (step S1402: YES), the multi-path driver 412 sets the recommended HBA driver version number to be the version number of the currently installed HBA driver (step S1403). After the operation at step S1403 comes to an end or if the multi-path driver 412 determines that the recommended HBA driver version number is not “0” (step S1402: NO), the multi-path driver 412 causes the HBA inquiry command response process to come to an end.

If the multi-path driver 412 determines that the return code included in the response indicates “4” (step S1401: 4), the multi-path driver 412 determines whether the recommended HBA driver version number is “0” (step S1404). If the multi-path driver 412 determines that the recommended HBA driver version number is not “0” (step S1404: NO), the multi-path driver 412 determines whether the recommended HBA driver version number is larger than the notified recommended HBA driver version number included in the response (step S1405).

If the multi-path driver 412 determines that the recommended HBA driver version number is “0” (step S1404: YES) or if the multi-path driver 412 determines that the recommended HBA driver version number is larger than the notified recommended HBA driver version number included in the response (step S1405: YES), the multi-path driver 412 sets the recommended HBA driver version number to be the notified recommended HBA driver version number included in the response (step S1406), sets the recommended HBA driver to be the notified recommended HBA driver included in the response (step S1407), and sets the HBA driver version number to be the notified recommended HBA driver version number included in the response (step S1408). After the operation at step S1408 comes to an end, the multi-path driver 412 causes the HBA inquiry command response process to come to an end.

On the other hand, if the multi-path driver 412 determines that the recommended HBA driver version number is equal to or smaller than the notified recommended HBA driver version number included in the response (step S1405: NO), the multi-path driver 412 causes the HBA inquiry command response process to come to an end.

If the multi-path driver 412 determines that the return code included in the response is “8” (step S1401: 8), the multi-path driver 412 outputs a message indicating “HBA is not supported” (step S1409). After the operation at step S1409 comes to an end, the multi-path driver 412 causes the HBA inquiry command response process to come to an end. The execution of the HBA inquiry command response process enables the multi-path driver 412 to identify for the selected HBA, the version number with which the operation of the storage apparatus 402 is guaranteed to be normal.

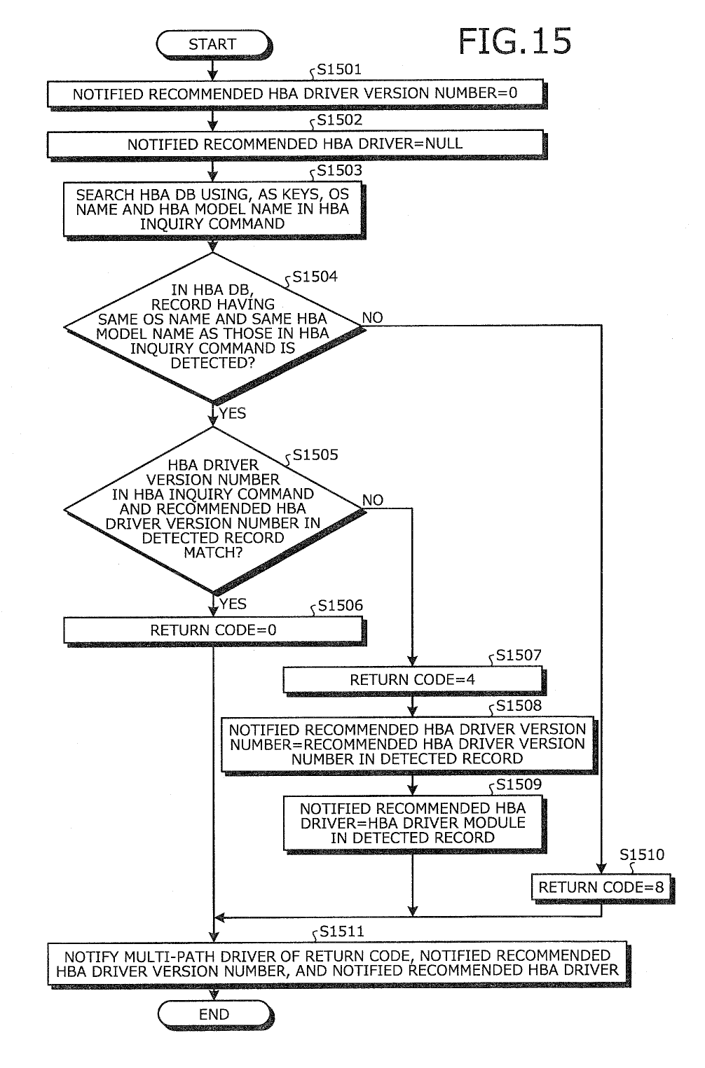

FIG. 15 is a flowchart of an example of a procedure for an HBA driver verification process executed by the storage apparatus. The HBA driver verification process executed by the storage apparatus is a process of verifying the HBA driver installed in the server 401 when the storage apparatus 402 receives the HBA inquiry command.

When the storage apparatus 402 receives the HBA inquiry command, the storage apparatus 402 sets the notified recommended HBA driver version number to be “0” (step S1501), sets the notified recommended HBA driver to be “null” (step S1502), searches the HBA DB 811 using, as keys, the OS name and the HBA model name in the HBA inquiry command (step S1503), and determines whether the storage apparatus 402 detects in the HBA DB 811, a record having therein the same OS name and the same HBA model name as those in the HBA inquiry command (step S1504).

If the storage apparatus 402 determines that the storage apparatus 402 detects a record having therein the same HBA model name as that in the HBA inquiry command (step S1504: YES), the storage apparatus 402 determines whether the version number of the HBA driver in the HBA inquiry command and the version number of the recommended HBA driver in the detected record match (step S1505). If the storage apparatus 402 determines that the version number of the HBA driver in the HBA inquiry command and the value of the version number of the recommended HBA driver of the detected record match (step S1505: YES), the storage apparatus 402 sets the return code to be “0” (step S1506).

If the storage apparatus 402 determines that the version number of the HBA driver in the HBA inquiry command and the value of the version number of the recommended HBA driver in the detected record do not match (step S1505: NO), the storage apparatus 402 sets the return code to be “4” (step S1507), sets the notified recommended HBA driver version number to be the recommended HBA driver version number in the detected record (step S1508), and sets the notified recommended HBA driver to be the HBA driver module in the detected record (step S1509).

If the storage apparatus 402 determines that the storage apparatus 402 can detect no record having the same HBA model name as that in the HBA inquiry command (step S1504: NO), the storage apparatus 402 sets the return code to be “8” (step S1510). After the operation at any one of steps S1506, S1509, and S1510 comes to an end, the storage apparatus 402 notifies the multi-path driver 412 of the return code, the notified recommended HBA driver version number, and the notified recommended HBA driver (step S1511). After the operation at step S1511 comes to an end, the storage apparatus 402 causes the HBA driver verification process executed by the storage apparatus to come to an end. The execution of the HBA driver verification process executed by the storage apparatus enables the storage apparatus 402 to verify the HBA driver version number notified by the multi-path driver 412.

As described, according to the storage apparatus 402, the HBA driver is verified based on the OS and the HBA of the higher-order system 101 by referring to the combination of the OS, the HBA, and the driver of the higher-order system whose operation is guaranteed to be normal. Thus, in performing verification, the storage apparatus 402 does not need to distinguish the combinations from each other concerning the HBA-connected apparatus. The amount of storage required for storing information concerning the proper HBA driver can be reduced by an amount corresponding to the unnecessary distinguishing of the combinations, and the amount can be reduced of the processing necessary for the searching for the information on the proper HBA driver. Therefore, the verification can efficiently be executed. When a verification result is output indicating that the correct HBA driver 413 is set, the manager only has to check the verification result and therefore, the storage system 400 can reduce the work steps necessary for setting the HBA driver 413 executed by the manager.

According to the storage apparatus 402, when the type of the HBA driver 413 to be set in the server 401 and the type of the HBA driver 413 set in the server 401 differ from each other, the HBA driver 413 to be set in the server 401 may be transmitted to the server 401. Thereby, the server 401 can set the HBA driver 413 to be set in the server 401 and can prevent occurrence of any malfunctioning caused by an inappropriate setting of the HBA driver 413. Even when a verification result is output indicating that the HBA driver 413 to be set is not set, it is easy for the manager to acquire the HBA driver 413 to be set and therefore, the work steps executed by the manager and necessary for setting the HBA driver 413 can be reduced.

According to the storage apparatus 402, the HBA driver 413 corresponding to the type of HBA driver may be downloaded from an external apparatus and may be correlated with the type of the HBA driver 413 and stored in the HBA DB 811. Thereby, the storage system 400 can eliminate the work performed by the manager of the storage system 400 and necessary for acquiring the HBA driver 413 that corresponds to the type of HBA driver 413.

According to the storage apparatus 402, when the verification request for the HBA driver 413 is received, the HBA driver 413 set in the server 401 may be verified. The verification request for the HBA driver 413 is issued when the storage system 400 is started up. Thus, the manager does not need to operate the server 101 to issue the verification request, whereby the storage system 400 can eliminate such work performed by the manager.

According to the server 401, the HBA driver 413 may be set based on the verification result received consequent to the transmission of the verification request for the HBA driver 413. Thus, when the verification result indicates that the verification is not executed, the server 401 can automatically correct any HBA driver to a verified HBA driver 413 whose operation is guaranteed to be normal.

According to the server 401, when the storage apparatus 402 is present in plural for one HBA 404 and plural verification results are received as a result of transmitting the verification request for the HBA driver 413, the HBA driver 413 whose version number is low may be set. Thus, the server 401 can set the HBA driver 413 by which all the storage apparatuses 402 normally operate.

The program performing the host bus driver verifying process described in the present embodiment may be implemented by being executed on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

According to an aspect of the embodiments, an effect is achieved that the driver for the host bus adaptor is efficiently verified.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A host bus driver verifying apparatus configured to be connected, through a host bus adapter, to a higher-order system, the host bus driver verifying apparatus comprising:
a storage device configured to preliminarily store correspondence relation information that correlates an operating system type operating in the higher-order system, a host bus adaptor type, and a driver type of the host bus adaptor; and
a processor configured to obtain for the host bus adaptor, the driver type to be set in the higher-order system to which connection is made, the processor obtaining the driver type based on the correspondence relation information stored in the storage device and connection information that includes information concerning the operating system type and the host adaptor type and that is received, via host bus adapter, from the higher-order system to which connection is made, the processor further configured to verify whether the obtained driver type matches a driver type set for a host bus adaptor in the higher-order system to which connection is made.

2. The host bus driver verifying apparatus according to claim 1, wherein
the correspondence relation information further indicates a driver of the host bus adaptor corresponding to the type of driver of the host bus adaptor, and
the processor, upon verifying that the driver type obtained for the host bus adaptor and the driver type set for the host bus adaptor in the higher-order system differ, transmits to the higher-order system, a driver that is for the host bus adaptor and that is to be set in the higher-order system to which connection is made.

3. The host bus driver verifying apparatus according to claim 2, wherein
the processor downloads from an external apparatus, a driver of the host bus adaptor corresponding to the driver type of the host bus adaptor and, correlates and stores to the storage unit, the downloaded driver and the driver type of the host bus adaptor.

4. The host bus driver verifying apparatus according to claim 1, wherein
the connection information is included in a verification request that is for a driver of the host bus adaptor and transmitted from a multi-path driver of the higher-order system to which connection is made, and
the processor, upon receiving the verification request for the driver of the host bus adaptor from the multi-path driver, obtains the driver type to be set for the host bus adaptor in the higher-order system to which connection is made, the processor obtaining the driver type based on the connection information and the correspondence relation information included in the verification request, and further verifying whether the obtain driver type matches the driver type set for the host bus adaptor in the higher-order system to which connection is made.

5. A system comprising:
a host bus adaptor that is connected to a host bus driver verifying apparatus; and
a processor that sets a driver of the host bus adaptor, based on a verification result received from the host bus driver verifying apparatus in response to a verification request for the driver of the host bus adaptor transmitted, via the host bus adaptor, to the host bus driver verifying apparatus and including connection information that includes information concerning an operating system type operating in the system and a host bus adaptor type.

6. The system according to claim 5, wherein
the host bus driver verifying apparatus connected to the host bus adaptor is present in plural, and
when verification results received from the host bus driver verifying apparatuses in response to the verification request transmitted, via the host bus adaptor, to the host bus driver verifying apparatuses, indicate that drivers to be set for host bus adaptors in the system respectively have a different version number, the processor sets the driver whose version number is smallest among the different version numbers.

7. A host bus verification system comprising:
a higher-order system; and
a host bus driver verifying apparatus configured to be connected, through a host bus adapter, to the higher-order system, wherein
the host bus driver verifying apparatus includes:
a storage device configured to preliminarily store correspondence relation information that correlates an operating system type operating in the higher-order system, a host bus adaptor type, and a driver type of the host bus adaptor; and
a first processor configured to obtain for the host bus adaptor, the driver type to be set in the higher-order system to which connection is made, the first processor obtaining the driver type based on the correspondence relation information stored in the storage device and connection information that includes information concerning the operating system type and the host adaptor type and that is received, via host bus adapter, from the higher-order system to which connection is made, the first processor further configured to verify whether the obtained driver type matches a driver type set for a host bus adaptor in the higher-order system to which connection is made, and
the higher-order system includes:
a host bus adaptor that is connected to the host bus driver verifying apparatus; and
a second processor that sets a driver of the host bus adaptor based on a verification result received from the host bus driver verifying apparatus consequent to a verification request for the driver of the host bus adaptor transmitted, via the host bus adaptor, to the host bus driver verifying apparatus and including connection information that includes information concerning an operating system type operating in the higher-order system and the host bus adaptor type.

8. A non-transitory, computer-readable recording medium storing a program of a host bus driver verifying apparatus connected to a higher-order system through a host bus adaptor, the program causing the host bus driver verifying apparatus to execute a process comprising:
obtaining a driver type to be set for the host bus adaptor in the higher-order system to which connection is made, the driver type being obtained based on correspondence relation information that is preliminarily stored in a storage device and correlates an operating system type operating in the higher-order system, a host bus adaptor type, and a driver type of the host bus adaptor, and further obtained based on connection information that includes information concerning the operating system type and the host bus adaptor type, and that is received, via the host bus adaptor, from the higher-order system to which connection is made; and
verifying whether the obtained driver type matches a driver type of a host bus adaptor set in the higher-order system to which connection is made.
